(19) United States
(12) Patent Application Publication
(10) Pub. No.: US 2008/0291198 A1
(43) Pub. Date: Nov. 27, 2008

(54) METHOD OF PERFORMING 3D GRAPHICS GEOMETRIC TRANSFORMATION USING PARALLEL PROCESSOR

(76) Inventors: Ik Jae Chun, Daejeon (KR); Jung Hee Suk, Daegu (KR); Yil Suk Yang, Daejeon (KR); Dae Woo Lee, Daejeon (KR); Tae Moon Roh, Daejeon (KR); Jong Dae Kim, Daejeon (KR); Ki Chul Kim, Seoul (KR); Jung Woo Lee, Seoul (KR)

Correspondence Address: LADAS & PARRY LLP, 224 SOUTH MICHIGAN AVENUE, SUITE 1600, CHICAGO, IL, 60604, US

(21) Appl. No.: 12/100,707

(22) Filed: Apr. 10, 2008

(30) Foreign Application Priority Data
May 22, 2007 (KR) 10-2007-0049844
Nov. 14, 2007 (KR) 10-2007-0115825

(51) Int. Cl. G06T 15/00

(52) U.S. Cl. 345/419

(57) ABSTRACT

Provided is a method of performing three-dimensional (3D) graphics geometric transformation using a parallel processor having a plurality of Processing Elements (PEs). The method includes performing model/view transformation and projection transformation on a first group of vertex vectors using the parallel processor; calculating a value used for quaternion correction of the first group of vertex vectors using a general-use processor, and simultaneously performing model/view transformation and projection transformation on a second group of vertex vectors; performing quaternion correction and screen mapping on the first group of vertex vectors, and simultaneously calculating a value used for quaternion correction of the second group of vertex vectors using the general-use processor; and performing quaternion correction and screen mapping on the second group of vertex vectors.

### CROSS-REFERENCE TO RELATED APPLICATION

This application claims priority to and the benefit of Korean Patent Application Nos. 2007-49844, filed May 22, 2007, and 2007-115825, filed Nov. 14, 2007, the disclosures of which are incorporated herein by reference in their entirety.

### BACKGROUND

1. Field of the Invention

The present invention relates to a method of performing three-dimensional (3D) graphics geometric transformation using a parallel processor, and more particularly, to a method of performing 3D graphics geometric transformation in parallel which supports parallel processing of 3D graphics geometric transformation using a parallel processor and thereby can simultaneously and efficiently perform a large amount of 3D graphic processing without a 3D accelerator.

The present invention is derived from research performed as a part of basic Information Technology (IT) technology development projects by the Ministry of Information and Communication (Republic of Korea) and the Institute for Information Technology Advancement (Republic of Korea) [Project Management Number: 2006-S-006-02. Project Title: Components/Module technology for Ubiquitous Terminals].

2. Discussion of Related Art

Recently, with a sudden increase in demand for portable terminals, such as Personal Digital Assistants (PDAs), cellular phones, etc., services provided to the portable terminals are increasing, as well as demand for various multimedia services, such as motion pictures, still images, audio, 3D graphics, etc. A general-use microprocessor embedded in a portable terminal has a poorer performance than a general Personal Computer (PC). In addition, the general-use microprocessor must perform various operations and thus does not have sufficient computation capability to support various multimedia services. Therefore, dedicated hardware is generally used for real time operation in a service module. To provide real time service for a variety of media using one portable terminal, dedicated hardware for the individual media must be installed in the terminal. The increase in hardware leads to an increase in cost as well as power consumption which reduces efficiency of the portable terminal.

Instead of using dedicated hardware for respective media services, a parallel processor may be used. In this method, services for all media are provided by one parallel processor. More specifically, using a reconfigurable array of processing elements in a parallel processor, an algorithm for a motion picture service is performed in the parallel processor when the motion picture service is provided, and an algorithm for an audio service is performed in the parallel processor when the audio service is provided. Since the method using a parallel processor does not need dedicated hardware, in comparison with the method using dedicated hardware for respective media service, it has characteristics of low cost, low power consumption, flexibility and high performance and provides various multimedia services, such as motion pictures, still images, audio, and so on.

However, most parallel processors perform only integer operations, and thus it is difficult for the parallel processors to process 3D graphics requiring a floating-point operation.

Therefore, a 3D graphics processor for a portable terminal, such as GoForce and RAMP, is additionally used together with a parallel processor, or dedicated hardware is installed and used. However, this causes hardware and cost to increase.

Currently, there is a typical parallel processor capable of processing 3D graphics, such as MiMagic. MiMagic can process 3D graphics without additional hardware. However, since MiMagic uses a fixed-point format and performs computation according to a 3D processing technique specialized for MiMagic, it is difficult to apply the 3D processing technique used in MiMagic to another parallel processor.

### SUMMARY OF THE INVENTION

The present invention is directed to providing a method of processing three-dimensional (3D) graphics geometric transformation in parallel using a parallel processor. More specifically, the present invention is directed to providing a method that can be easily applied to a parallel processor and efficiently perform 3D graphics geometric transformation requiring a large amount of computation without additional hardware for 3D graphics.

One aspect of the present invention provides a method of performing 3D graphics geometric transformation using a parallel processor having a plurality of processing elements (PEs), the method comprising: performing model/view transformation and projection transformation on a first group of vertex vectors using the parallel processor; calculating a value used for quaternion correction of the first group of vertex vectors using a general-use processor, and simultaneously performing model/view transformation and projection transformation on a second group of vertex vectors; performing quaternion correction and screen mapping on the first group of vertex vectors, and simultaneously calculating a value used for quaternion correction of the second group of vertex vectors using the general-use processor; and performing quaternion correction and screen mapping on the second group of vertex vectors.

### BRIEF DESCRIPTION OF THE DRAWINGS

The above and other objects, features and advantages of the present invention will become more apparent to those of ordinary skill in the art by describing in detail exemplary embodiments thereof with reference to the attached drawings, in which:

FIG. 1 is a block diagram illustrating the steps of a geometry stage in three-dimensional (3D) graphics processing;

FIG. 2 is a flowchart showing a method of performing 3D graphics geometric transformation in parallel according to an exemplary embodiment of the present invention;

FIG. 3 is a block diagram of a parallel processor that can be used for an exemplary embodiment of the present invention;

FIG. 4 illustrates bit structures according to an Institute of Electrical and Electronics Engineers (IEEE) 754 single-precision format, a 24-bit floating-point format used in the present invention, and a 24-bit floating-point format divided and stored in two 16-bit registers;

FIG. 5 illustrates a process that a Processing Element (PE) must perform depending on a multiplication result of a mantissa part according to an exemplary embodiment of the present invention;

FIG. 6 is a flowchart showing a matrix multiplication process according to an exemplary embodiment of the present invention; and

FIGS. 7 to 11 illustrate a matrix multiplication process according to an exemplary embodiment of the present invention.

### DETAILED DESCRIPTION OF EXEMPLARY EMBODIMENTS

Hereinafter, exemplary embodiments of the present invention will be described in detail. However, the present invention is not limited to the embodiments disclosed below, but can be implemented in various forms. The following embodiments are described in order to enable those of ordinary skill in the art to embody and practice the present invention.

First, to aid in understanding the present invention, a three-dimensional (3D) graphics process will be described briefly. In general, the 3D graphics process may be divided into an application stage, a geometry stage and a rasterizer stage. In the application stage, various operations are performed according to a used application program, and texture animation, animations via transformation, geometry morphing, etc., may be implemented. At the end of the application stage, objects to be processed as graphics are transferred to the geometry stage. The geometry stage is divided into a transformation stage of performing position transformation on objects expressed by vertices transferred from the application stage, and a lighting stage of determining colors of the vertices. Data passed through the geometry stage are transferred to the rasterizer stage. In the rasterizer stage, per-vertex position data and color data of the objects consisting of vertices transferred from the geometry stage are converted into per-pixel position data and color data by interpolation, thereby imparting colors.

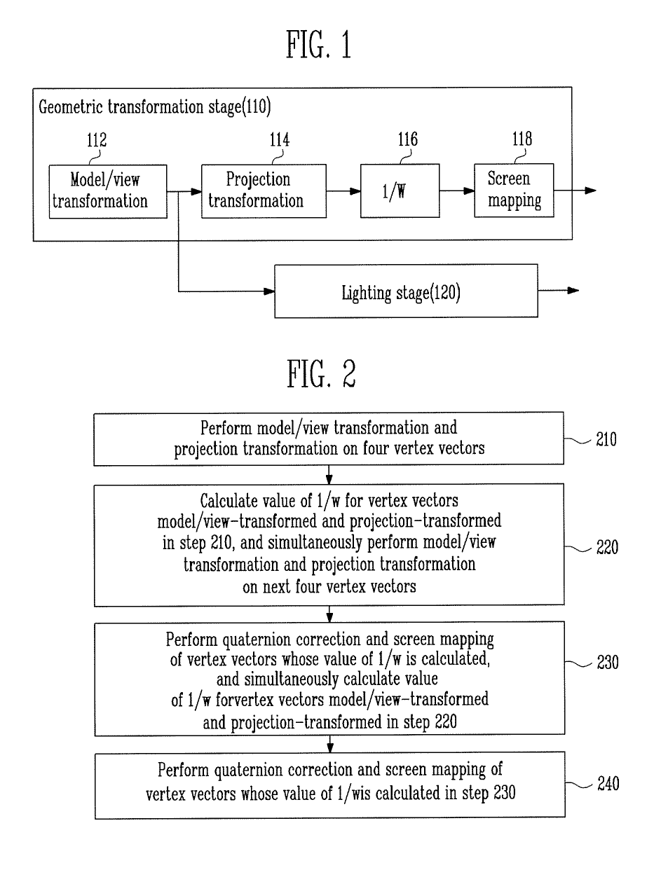

FIG. 1 is a block diagram illustrating the steps of a geometry stage in 3D graphics processing. As illustrated in the drawing, the geometry stage is divided into a geometric transformation stage 110 and a lighting stage 120. The geometric transformation stage 110 includes a model/view transformation step 112, a projection transformation step 114, a quaternion correction step (1/w) 116 and a screen mapping step 118. The model/view transformation step 112, the projection transformation step 114 and the screen mapping step 118 all comprise 4×4 matrix transformation and thus are performed by floating-point matrix multiplication. On the other hand, the quaternion correction step 116 is performed by dividing x, y and z elements by a w element. Here, the quaternion correction step 116 is a process of correcting a point processed through the projection transformation step 114. In 3D graphics processing, a vector is expressed by (x, y, z, 0)^{T}, and a point is expressed by (x, y, z, 1)^{T}. wₚ of a new point P=(xₚ, yₚ, zₚ, wₚ)^{T} processed through the projection transformation step 114 has a value that is neither 0 nor 1. Therefore, it is possible to obtain an actually projected point (x, y, z, 1)^{T} after the quaternion correction step 116 of dividing xₚ, yₚ and zₚ elements by a wₚ element. Consequently, the geometric transformation stage 110 can be performed through only floating-point multiplication, addition and division.

In the present invention, floating-point multiplication is performed by Processing Elements (PEs) in a parallel processor. Floating-point multiplication can be rapidly performed through only a basic integer operation using PEs. Meanwhile, floating-point addition and division require a complex computation process and a large amount of computation time, and thus it is inefficient to perform floating-point addition and division using only PEs. To rapidly process 3D graphics in the present invention, floating-point addition is performed by floating-point accumulators, and floating-point division is performed by a general-use processor.

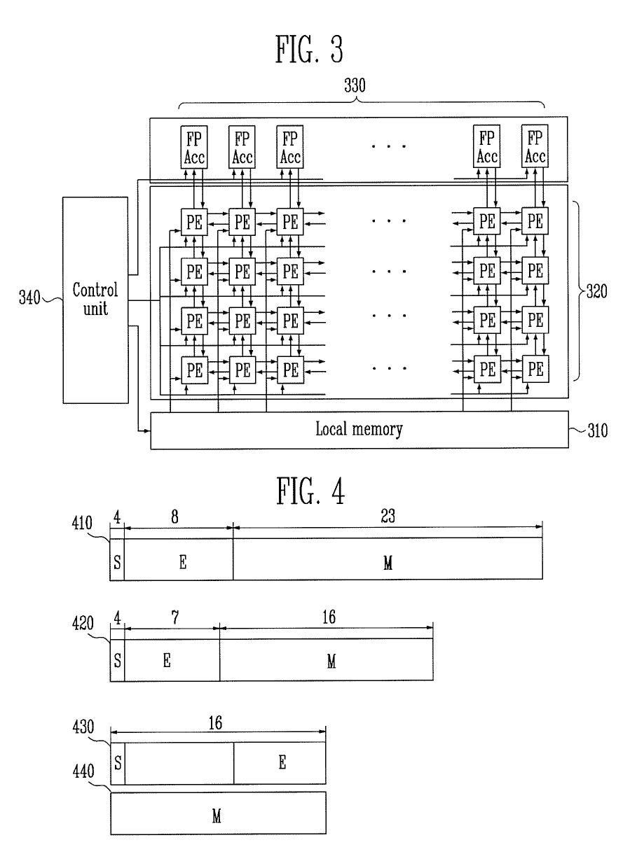

FIG. 2 is a flowchart showing a method of performing 3D graphics geometric transformation in parallel according to an exemplary embodiment of the present invention. FIG. 2 shows an example of a process of performing geometric transformation in units of four vertex vectors. As illustrated in FIG. 2, four vertex vectors are model/view-transformed and projection-transformed through two successive 4×4 matrix multiplication operations. The 4×4 matrix multiplication operations are performed by PEs in a parallel processor. The four vertex vectors are model/view-transformed through the first 4×4 matrix multiplication operation and projection-transformed through the next 4×4 matrix multiplication operation. The matrix multiplication operations according to an exemplary embodiment of the present invention will be described in detail below.

In step 220, values of 1/w required for quaternion correction of the vertex vectors model/view-transformed and projection-transformed in step 210 are calculated, and simultaneously four vertex vectors to be processed next are model/view-transformed and projection-transformed. It takes significant time to divide x, y and z elements by a w element for quaternion correction. Therefore, in an exemplary embodiment of the present invention, a value of w is transferred to a general-use processor to calculate a value of 1/w, and then the value of 1/w is loaded into the respective PEs in the parallel processor so that the respective PEs perform floating-point multiplication. Each of the PEs may multiply the x, y and z elements by the loaded value of 1/w to yield the same result as that obtained by dividing the x, y and z elements by the w element. Here, delay time is required for the general-use processor to calculate the value of 1/w and transfer it to the PEs. Thus, the PEs may load the four vertex vectors to be computed next and perform model/view transformation and projection transformation during the delay time in which the general-use processor calculates a value of 1/w.

In step 230, a 4×4 matrix multiplication operation is performed twice on the vertex vectors whose values of 1/w are calculated in step 220 to perform quaternion correction and screen mapping, and values of 1/w for the vertex vectors model/view-transformed and projection-transformed in step 220 are simultaneously calculated by the general-use processor. Here, the two 4×4 matrix multiplication operations are performed by the PEs in the parallel processor. In this way, a geometric transformation process for the first four vertex vectors is completed.

In step 240, the values of 1/w calculated in step 230 are loaded into the respective PEs of the parallel processor to perform quaternion correction on the vertex vectors model/view-transformed and projection-transformed in step 220, and then screen mapping is performed, thereby completing a geometric transformation process.

A process in which geometric transformation is performed on first four vertex vectors and next four vertex vectors in parallel is described above. However, it is apparent to those skilled in the art that more vertex vectors can be geometrically transformed in parallel by repeating the above described steps. More specifically, in 3D graphics geometric transformation according to an exemplary embodiment of the present invention, calculation of values of 1/w for vertex vectors already model/view-transformed and projection-transformed is performed in parallel with model/view-transformation and projection transformation of vertex vectors to be subsequently processed, and also quaternion correction and screen mapping of the vertex vectors already model/view-transformed and projection-transformed are performed in parallel with calculation of the values of 1/w for the vertex vectors to be processed next, thereby allowing an efficient parallel process.

FIG. 3 is a block diagram of a parallel processor that can be used for an exemplary embodiment of the present invention. As illustrated in the drawing, a parallel processor 300 comprises a PE array 320, a local memory 310 directly connected with the PE array 320, a floating-point accumulator array 330 for accelerating a floating-point addition operation, and a control unit 340 for controlling the blocks 310, 320 and 330. The floating-point accumulator array 330 connected with uppermost PEs of the PE array 320 comprises accumulators numbering the same as PEs included in one row of the PE array 320, and the accumulators are connected with PEs of the same columns among PEs of the uppermost row in the PE array 320 to exchange data. The floating-point accumulator array 330 is used for accelerating an addition operation of floating-point matrix multiplication in a 3D graphics geometric transformation process of the present invention.

However, the above described structure of the parallel processor is an example, and the present invention is not limited thereto. The present invention can be applied to any parallel processor having the characteristics given below.

(1) Computation of PEs in a parallel processor and data transfer between the PEs can be separately and simultaneously performed.

(2) PEs in a parallel processor can execute a conditional statement.

(3) PEs in a parallel processor can perform integer multiplication, addition, subtraction, shift, logical operation, and so on.

(4) One set of floating-point accumulators are added to one side of a parallel processor and connected with PEs.

It is assumed below that a parallel processor used in the present invention has all the above mentioned characteristics, respective PEs perform a 16-bit operation, and a 24-bit floating-point format is used. In a 3D graphic accelerator of a Personal Computer (PC), an Institute of Electrical and Electronics Engineers (IEEE) 754 single-precision format is frequently used as a floating-point format. However, 24-bit floating-point precision is enough for 3D graphics processing of, for example, OpenGL and DirectX, and is widely used in portable terminals. Thus, it is assumed that 24-bit floating-point precision is also used in the present invention.

FIG. 4 illustrates bit structures according to an IEEE 754 single-precision format 410, a 24-bit floating-point format 420 used in the present invention, and a 24-bit floating-point format 430 and 440 divided and stored in two 16-bit registers. As illustrated in FIG. 4, the IEEE 754 single-precision format 410 has 1 bit for a sign, 8 bits for an exponent and 23 bits for a mantissa. On the other hand, the 24-bit floating-point format 420 used in the present invention has 1 bit for a sign, 7 bits for an exponent and 16 bits for a mantissa and also has a hidden bit as in the IEEE 754 single-precision format 410. In order to store a 24-bit floating-point format in 16-bit registers, the present invention separately stores a sign part and an exponent part in the uppermost bit and lower bits of a first register and stores a mantissa part in a second register.

An operation most frequently used in the above described 3D graphics geometric transformation process according to an exemplary embodiment of the present invention is floating-point matrix multiplication. In a geometric transformation process, matrix multiplication is performed to process a vertex. Thus, it is possible to perform a geometric transformation process when floating-point matrix multiplication is supported. Matrix multiplication is performed through floating-point multiplication and floating-point addition using floating-point accumulators positioned above PEs.

First, a floating-point multiplication operation process according to an exemplary embodiment of the present invention will be described. For convenience, it is assumed that when two floating-point values F1 and F2 are multiplied by each other to output an output value F3, F1 and F2 are stored in registers R1, R2, R3 and R4 as given below.

R1: sign and exponent parts of F1

R2: mantissa part of F1

R3: sign and exponent parts of F2

R4: mantissa part of F2

Values stored in R1 and R2 are added together using an Arithmetic Logic Unit (ALU) of a PE and stored in R5. In this floating-point multiplication, exponent bits of the two inputs must be added together, and R1 and R3 are added together to generate a correct sign. For multiplication of mantissa parts, values stored in R2 and R4 are multiplied by each other using an 18-bit two's complement array multiplier of the PE, and the result value is stored in R2 and R3. Here, 17 bits including a hidden bit are needed for multiplication of mantissa parts, which is different from general integer multiplication. In the present invention, a floating-point multiplication instruction for floating-point operation is defined to support multiplication of mantissa parts together with general integer multiplication when floating-point multiplication is performed. When the floating-point multiplication instruction is input, 1 bit is attached to the uppermost bit of an input 16-bit value to perform 17-bit multiplication. On the other hand, when a general multiplication instruction is input, 16-bit multiplication is performed using an input 16-bit value as it is. Referring to multiplication of mantissa parts in floating-point multiplication, when a mantissa part including a hidden bit is converted into an actual value, it has a value of a minimum of 1.0000000000000000 to a maximum of 1.1111111111111111. Therefore, when multiplication of 17-bit mantissa parts is performed, 34 bits are output. 34-bit outputs may be classified as given below.

01.XXXXXXXXXXXXXXXX

10.XXXXXXXXXXXXXXXX

11.XXXXXXXXXXXXXXXX

When the uppermost bit of the mantissa multiplication result is 0, exception handling is performed without correcting an exponent part of the result. On the other hand, when the uppermost bit is 1, the exponent part must be increased by 1, and the mantissa part must be shifted by 1 bit.

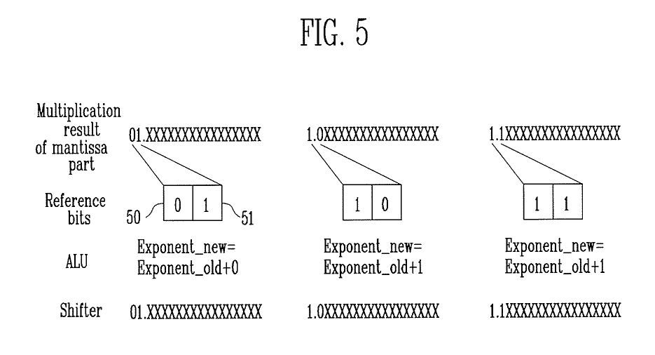

FIG. 5 illustrates a process that a PE must perform depending on a multiplication result of a mantissa part according to an exemplary embodiment of the present invention. A PE capable of executing a conditional statement normalizes an exponent part with reference to a first bit 50 and a mantissa part with reference to a second bit 51. When the exponent part and mantissa part are normalized, exception handling is performed. Exception handling is performed using 0 when underflow occurs, and using the maximum value when overflow occurs. The floating-point multiplication process is briefly shown in Table 1 below.

TABLE 1

| Step | Instruction | Description |
|---|---|---|
| 1 | ADD R5, R1, R3 | R1 + R3 → R5 |
| 2 | MUL R2, R2, R4 | R2 * R4 → R2 (store flag) |
| 3 | VSHFT R2, R2 | if flag1 = 1, shift R2 >> 1 → R2 |
| 4 | ADD R5, R5 | if flag1 = 1, R5 + 1 → R5 |
| 5 | SUB R1, R5, 63 | R5 − 63 → R1 |
| 6 | AND R3, R1, 0x4000 | R1 & 0x4000 → R3 (store flag) |
| 7 | AND R1, R5, 0x8000 | if zero = 0, R5 & 0x8000 → R1 |
| 8 | AND R2, R2, 0x0000 | if zero = 0, R2 & 0x0000 → R2 |
| 9 | AND R3, R1, 0x7FFF | R1 & 0x7FFF → R3 |
| 10 | SUB R3, R3, 0x007E | R3 − 0x007E → R3 (store flag) |
| 11 | AND R3, R1, 0x8000 | if negative = 0, R1 & 0x8000 → R3 |
| 12 | OR R1, R3, 0x007E | if negative = 0, R3 \| 0x007E → R1 |
| 13 | OR R2, R2, 0xFFFF | if negative = 0, R2 \| 0xFFFF → R2 |

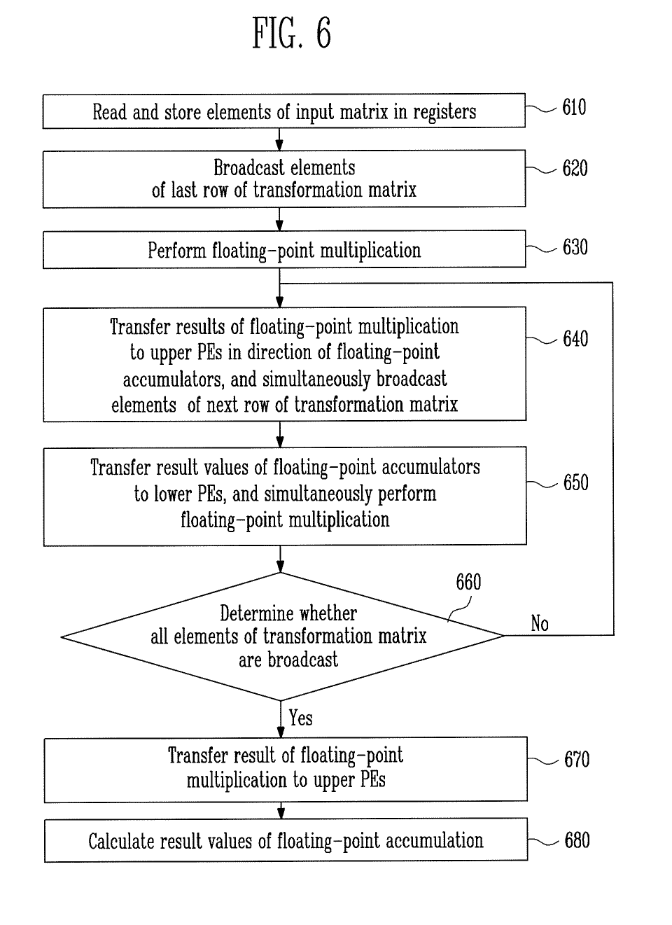

A 4×4 matrix multiplication process required for geometric transformation according to an exemplary embodiment of the present invention will be described in detail below with reference to FIG. 6. For convenience, a matrix multiplication process between an input matrix X and a transformation matrix T used in Equation 1 below will be described as an example. It is assumed that elements of the input matrix X are stored in a local memory.

$$\begin{matrix}Y = T * X \\ = ( \begin{matrix}a & b & c & d \\ e & f & g & h \\ i & j & k & l \\ m & n & o & p\end{matrix} ) * ( \begin{matrix}1 & 2 & 3 & 4 \\ 5 & 6 & 7 & 8 \\ 9 & 10 & 11 & 12 \\ 13 & 14 & 15 & 16\end{matrix} ) \\ = ( \begin{matrix}A & B & C & D \\ E & F & G & H \\ I & J & K & L \\ M & N & O & P\end{matrix} )\end{matrix} \\ \begin{matrix}\begin{matrix}\begin{matrix}\begin{matrix}A = a 1 + b 5 + c 9 + d 13 \\ B = a 2 + b 6 + c 10 + d 14\end{matrix} \\ C = a 3 + b 7 + c 11 + d 15\end{matrix} \\ D = a 4 + b 8 + c 12 + d 15\end{matrix} & \begin{matrix}\begin{matrix}\begin{matrix}I = i 1 + j 5 + k 9 + I 13 \\ J = i 2 + j 6 + k 10 + I 14\end{matrix} \\ K = i 3 + j 7 + k 11 + I 15\end{matrix} \\ L = i 4 + j 8 + k 12 + I 15\end{matrix} \\ \begin{matrix}\begin{matrix}\begin{matrix}E = e 1 + f 5 + g 9 + h 13 \\ F = e 2 + f 6 + g 10 + h 14\end{matrix} \\ G = e 3 + f 7 + g 11 + h 15\end{matrix} \\ H = e 4 + f 8 + g 12 + h 15\end{matrix} & \begin{matrix}\begin{matrix}\begin{matrix}M = m 1 + n 5 + o 9 + p 13 \\ N = m 2 + n 6 + o 10 + p 14\end{matrix} \\ O = m 3 + n 7 + o 11 + p 15\end{matrix} \\ P = m 4 + n 8 + o 12 + p 16\end{matrix}\end{matrix} \qquad [ Equation 1 ]$$

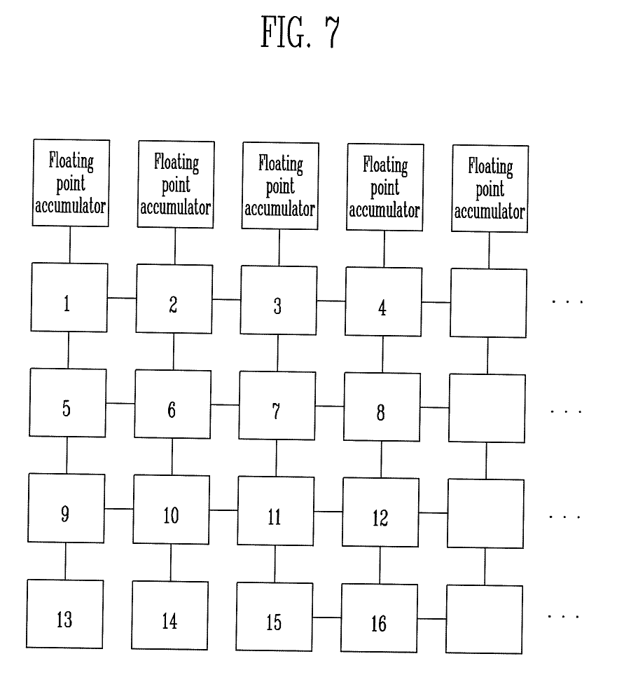

In step 610, the elements of the input matrix X stored in the local memory are read and stored as initial values in registers of respective PEs (see FIG. 7).

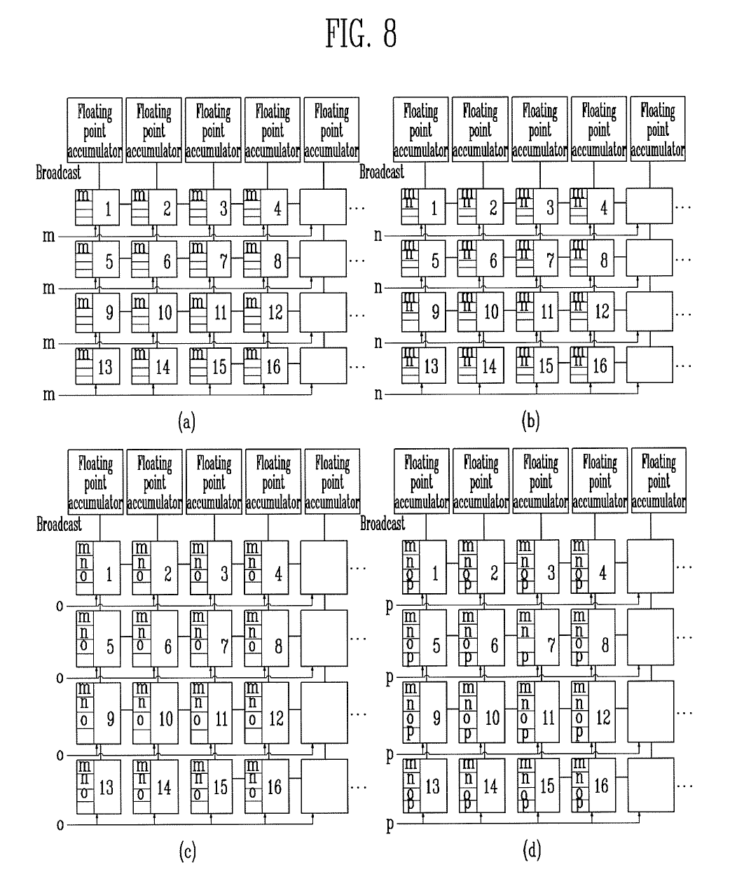

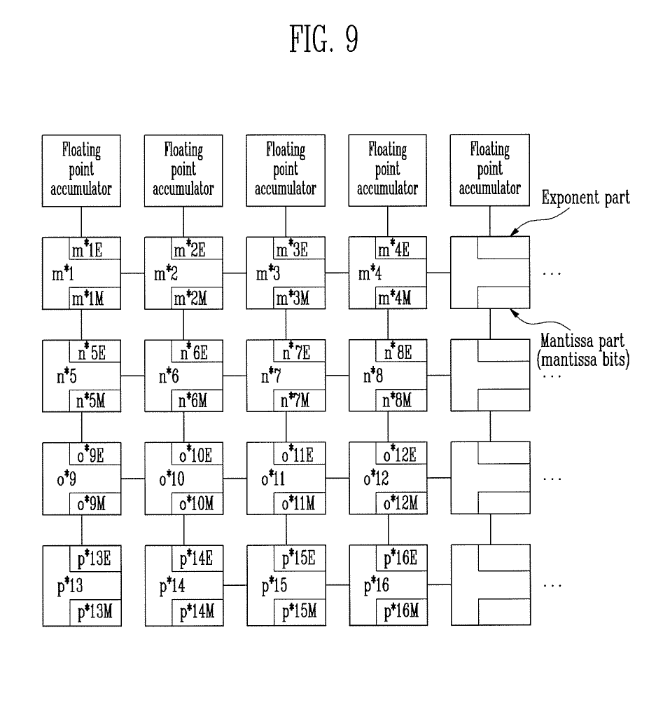

In step 620, m, n, o and p, which are elements of the last row of the transformation matrix T, are broadcast to respective PE rows in order to calculate M, N, O and P, which are elements of the last row of an output matrix Y of Equation 1 (see FIGS. 8A to 8D). PEs of each row store m, n, o and p required for matrix multiplication in the local register. The present invention is characterized by broadcasting rows of the transformation matrix T in reverse order of rows from the last row of the transformation matrix T to the first row to calculate result values in reverse order of rows from the last row of the output matrix Y to the first row, that is, in order of (M, N, O, P), (I, J, K, L), (E, F, G, H) and (A, B, C, D).

In step 630, the PEs perform floating-point multiplication by multiplying respective rows of the input matrix X by m, n, o and p. Floating-point multiplication may be performed according to the above described method. When floating-point multiplication is completed, a mantissa part and an exponent part of the result value are stored in registers, respectively (see FIG. 9).

In step 640, while the results of floating-point multiplication performed in the previous step are transferred to upper PEs existing in a direction of floating-point accumulators, elements of a next row in the transformation matrix T are broadcast to the PEs. Here, the term “next row” denotes a next row in reverse order of rows broadcast in the previous step and thus is i, j, k and l.

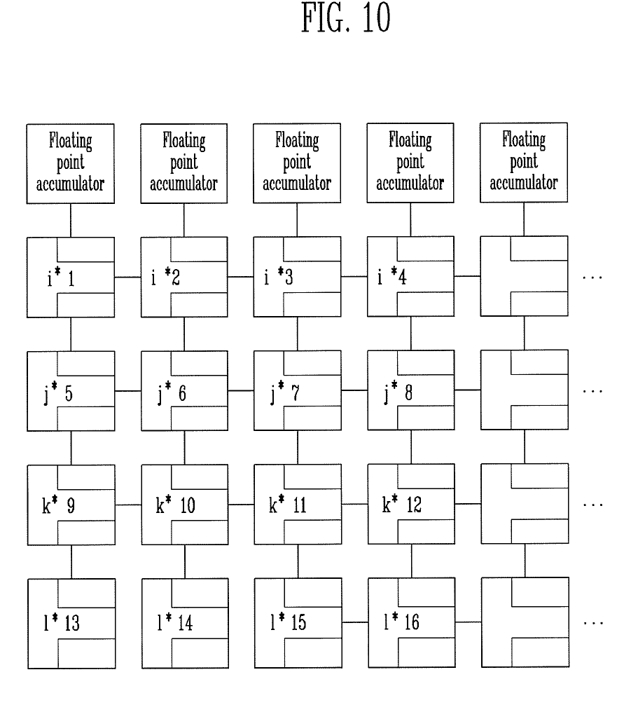

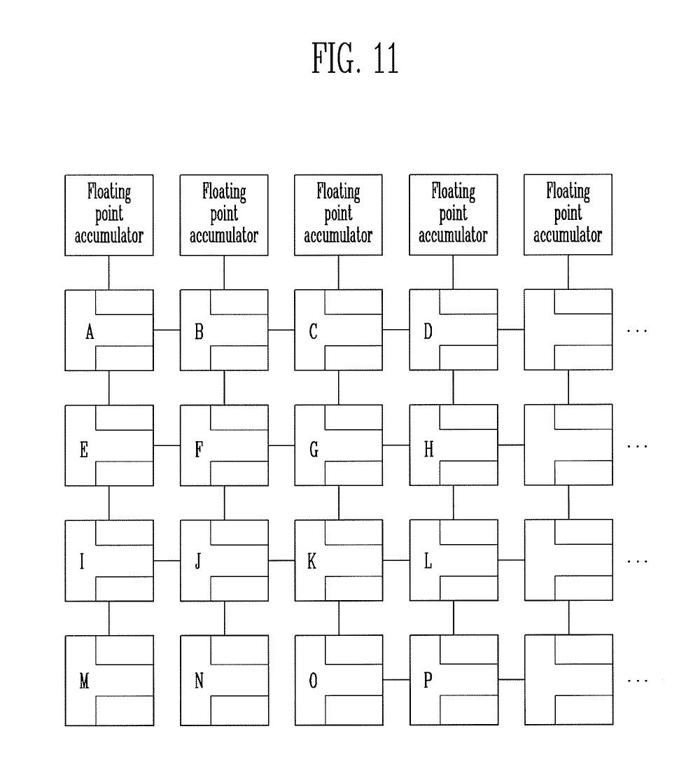

In step 650, while floating-point multiplication of multiplying elements of each row of the input matrix X by i, j, k and l is performed to calculate values I, J, K and L, values M, N, O and P, which are final result values accumulated by the floating-point accumulators, are transferred to lower PEs. Such a parallel process is possible because computation of the PEs and data transfer can be simultaneously performed. FIG. 10 illustrates a parallel processor right after floating-point multiplication for calculating the values I, J, K and L is completed. Right after floating-point multiplication is completed, the values M, N, O and P are stored in the lowermost PEs, and result values of floating-point multiplication for calculating the values I, J, K and L are stored in other registers.

In step 660, it is determined whether all elements of the transformation matrix T are broadcast. When all elements of the transformation matrix T are not broadcast, the above described steps 640 and 650 are repeated to calculate values A, B, C, D, E, F, G and H. When the floating-point multiplication for calculating the values A, B, C and D is completed, the result values are transferred to upper PEs in the direction of the floating-point accumulators (step 670), and then result values of floating-point accumulation are calculated (step 680). In this way, matrix multiplication is completed.

Finally, it is possible to obtain computation results as shown in FIG. 11. As illustrated in the drawing, an array of a result matrix is the same as that of the input matrix X, and thus it is possible to repeatedly perform matrix multiplication using the above described method. If matrix multiplication is repeatedly performed, data is transferred for floating-point accumulation, and simultaneously elements of a next row are broadcast (or loaded) when floating-point multiplication for calculating the values A, B, C and D is completed. Subsequently, the above described method is repeatedly performed.

On the basis of the above described matrix multiplication method, it is possible to efficiently perform 3D graphics geometric transformation in parallel.

The method of performing 3D graphics geometric transformation in parallel using a parallel processor according to an exemplary embodiment of the present invention supports a floating-point operation using PEs and floating-point accumulators in the parallel processor without additional hardware and thus can efficiently perform 3D graphics geometric transformation. Only characteristics of a parallel processor required for the present invention need to be satisfied for the method according to an exemplary embodiment of the present invention to be easily applied to any parallel processor. According to an exemplary embodiment of the present invention, hardware for 3D graphics is not necessary, and thus it is possible to process 3D graphics requiring a large amount of computation using a small area and low cost.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. A method of performing three-dimensional (3D) graphics geometric transformation using a parallel processor having a plurality of processing elements (PEs), the method comprising:
performing model/view transformation and projection transformation on a first group of vertex vectors using the parallel processor;
calculating a value used for quaternion correction of the first group of vertex vectors using a general-use processor, and simultaneously performing model/view transformation and projection transformation on a second group of vertex vectors;
performing quaternion correction and screen mapping on the first group of vertex vectors, and simultaneously calculating a value used for quaternion correction of the second group of vertex vectors using the general-use processor; and
performing quaternion correction and screen mapping on the second group of vertex vectors.

2. The method of claim 1, wherein the model/view transformation and the projection transformation are performed through two matrix multiplication operations.

3. The method of claim 1, wherein the quaternion correction is performed by loading the value calculated by the general-use processor to be used for quaternion correction into the PEs and multiplying the value by elements previously stored in the PEs.

4. The method of claim 1, wherein the screen mapping is performed through a matrix multiplication operation.

5. The method of claim 2, wherein the matrix multiplication operation is performed through floating-point multiplication and addition operations, the floating-point multiplication operation is performed by the PEs, and the floating-point addition operation is performed by floating-point accumulators in the parallel processor.

6. The method of claim 5, wherein the floating-point accumulators are positioned above the PEs in the parallel processor.

7. The method of claim 5, wherein when an output matrix is obtained by multiplying an input matrix and a transformation matrix together in the matrix multiplication operation, elements of the transformation matrix are broadcast to the PEs in reverse order from a last row to a first row to calculate result values of the output matrix in reverse order from a last row to a first row.

8. The method of claim 7, wherein the elements of the transformation matrix are broadcast to the PEs while result values of floating-point multiplication stored in the PEs are transferred to upper PEs in a direction of the floating-point accumulators.

9. The method of claim 7, wherein result values of the floating-point accumulators are transferred to lower PEs while floating-point multiplication is performed by the PEs.

10. The method of claim 5, wherein the floating-point multiplication is performed on values represented in a 24-bit floating-point format.

11. The method of claim 10, wherein the 24-bit floating-point format has 1 bit for a sign, 7 bits for an exponent and 16 bits for a mantissa.

12. The method of claim 11, wherein each of the values represented in the 24-bit floating-point format is stored in two 16-bit registers, the 1 bit for a sign and the 7 bits for an exponent are separately stored in an uppermost bit and lower bits of a first register, and the 16 bits for a mantissa are stored in a second register.

13. The method of claim 11, wherein when the floating-point multiplication is performed, 1 bit is attached to the 16-bit mantissa to perform multiplication of the mantissa represented in 17 bits, and normalization of the exponent and the mantissa is performed with reference to uppermost two bits of a multiplication result of the mantissa.
